(19) United States
(12) Patent Application Publication
(10) Pub. No.: US 2019/0003429 A1
(43) Pub. Date: Jan. 3, 2019

(54) INTAKE MANIFOLD

(71) Applicant: HONDA MOTOR CO., LTD., Tokyo (JP)

(72) Inventor: Yoichi MIYASHITA, Wako-shi (JP)

(21) Appl. No.: 16/017,003

(22) Filed: Jun. 25, 2018

(30) Foreign Application Priority Data
Jun. 30, 2017 (JP) 2017-128794

(51) Int. Cl. F02M 35/10; F02M 35/104

(52) U.S. Cl. CPC F02M 35/10222; F02M 35/104; F02M 35/1038

(57) ABSTRACT

In an intake manifold (20) having a main pipe (21) extending in a cylinder row direction of the engine, and having an intake inlet (24) in one end part thereof; a plurality of branch pipes (22) extending from the main pipe to respective intake ports (7) of the engine, a blowby gas introduction hole (31) is provided in a part of the main pipe located between the intake inlet and a center of the main pipe with respect to the cylinder row direction, an intake pressure sensor (40) is provided in another end part of the main pipe remote from the one end part thereof.

### TECHNICAL FIELD

The present invention relates to an intake manifold for an internal combustion engine.

### BACKGROUND ART

It is known to provide a blowby gas introduction hole (PCV port) and a negative pressure introduction hole in an intake manifold of an internal combustion engine. The blowby gas introduction hole is used for introducing blowby gas into the combustion chambers via the intake manifold, and the negative pressure introduction hole is used for receiving a negative pressure sensor for measuring an intake pressure of the engine. See JP2014-105604A, for instance. The intake manifold disclosed in JP2014-105604A includes a surge tank elongated in the cylinder row direction of the engine, an intake introduction pipe connected to a lengthwise middle part of the surge tank, and four branch pipes arranged along the length of the surge tank. The blowby gas introduction hole is provided in a lengthwise end part of the surge tank while the negative pressure introduction hole is provided in a lengthwise middle part of the surge tank.

In such an arrangement, it is known that moisture contained in the blowby gas may condense in the negative pressure introduction hole, and may freeze therein in cold weather. To avoid this problem, the negative pressure introduction hole is shielded by a partition wall to minimize exposure to the blowby gas.

However, the presence of such a partition wall obstructs a smooth flow of the air flow so that the flow rates of intake air among the different branch pipes may become uneven. Also, when the blowby gas introduction hole is provided in an end part of the surge tank, the blowby gas may be distributed to the different branch pipes in an uneven manner.

### SUMMARY OF THE INVENTION

In view of such problems of the prior art, a primary object of the present invention is to provide an intake manifold for an internal combustion engine provided with a blowby gas introduction hole and an intake air pressure sensor that allows the blowby gas to be distributed evenly to different branch pipes of the intake manifold, and minimizes the exposure of the intake air pressure sensor to the blowby gas.

To achieve such an object, one aspect of the present invention provides an intake manifold (20) for an internal combustion engine (1) including a plurality of cylinders arranged in a row, comprising: a main pipe (21) extending in a cylinder row direction of the engine, and having an intake inlet (24) in one end part thereof; a plurality of branch pipes (22) extending from the main pipe to respective intake ports (7) of the engine; a blowby gas introduction hole (31) provided in a part of the main pipe located between the intake inlet and a center of the main pipe with respect to the cylinder row direction; and an intake pressure sensor (40) provided in another end part of the main pipe remote from the one end part thereof.

Since the blowby gas introduction hole is provided on an intake inlet side of the main pipe, the branch pipe or the branch pipes on the intake inlet side of the main pipe is or are enabled to receive ample amounts of blowby gas so that the blowby gas is evenly distributed among the different branch pipes. Since the intake pressure sensor is located in the other end part of the main pipe remote from the intake inlet, the blowby gas introduced from the blowby gas introduction hole is directed toward the branch pipes so that the intake pressure sensor is less exposed to the blowby gas, and is hence protected from the corrosive effect of the blowby gas. Furthermore, pressure changes in the intake air that can be caused by changes in the opening angle of the throttle valve is attenuated as the intake air travels the length of the main pipe so that the intake pressure sensor is protected from the pressure fluctuations caused by the throttle valve. Therefore, the intake pressure sensor is enabled to measure the pressure in the main pipe in an accurate and reliable manner.

Preferably, the intake pressure sensor is provided on a side of the main pipe facing away from the cylinder head.

This allows the intake pressure sensor to be further protected from the blowby gas.

Preferably, the intake pressure sensor is provided in an upper part of the main pipe.

This prevents condensed water that may be released from the blowby gas from contacting the intake pressure sensor so that the durability of the intake pressure sensor can be improved, and a high level of accuracy of the intake pressure sensor can be ensured.

Preferably, the intake pressure sensor is provided in a range extending from a vertical line (V) passing through a center line (A) of the main pipe extending in the cylinder row direction to a line forming a 35 degree angle relative to the vertical line around the center line.

This allows the intake pressure sensor to be protected from condensed water in an even more favorable manner.

Preferably, the intake pressure sensor is provided adjacent to the branch pipe (24A) most remote from the one end of the main pipe.

Thereby, the intake pressure sensor is placed in a part of the main pipe which is relatively free from pressure fluctuations that could be caused by the operation of the throttle valve, and can therefore measure the pressure in the main pipe with a high accuracy.

This is particularly the case when the intake pressure sensor is located between two straight lines obtained by extrapolating side edges of an inner surface of the branch pipe most remote from the one end of the main pipe in plan view.

Preferably, a pressure receiving part of the intake pressure sensor is positioned in a hole (32) or recess (43) formed in a wall of the main pipe.

Thereby, the hole or the recess dampens sharp changes in pressure in the main pipe so that the intake pressure sensor can measure the pressure in the main pipe with a high accuracy.

Preferably, the branch pipes extend from a side of the main pipe facing the cylinder head with an upward slant followed by a downward curve, and the blowby gas introduction hole is formed in an upper part of a side of the main pipe facing away from the cylinder head.

Because the path of the blowby gas in each branch pipe is extended, and hence the length of the path of the blowby gas as measured from the blowby gas introduction hole is extended, the blowby gas can be distributed among the different branch pipes in a relatively even manner.

Preferably, an inner end of the blowby gas introduction hole extends substantially vertically.

Thereby, the flow of the blowby gas in the main pipe is provided with an increased amount of circumferential component so that the blowby gas can be distributed among the different branch pipes in a relatively even manner owing to the long path which the blowby gas has to travel before reaching each intake port.

According to a preferred embodiment of the present invention, the branch pipes include a first branch pipe, a second branch pipe, a third branch pipe and a fourth branch pipe arranged in that order from the other end part of the main pipe, and the blowby gas introduction hole is located adjacent to the third branch pipe (24C).

Thereby, the blowby gas can be distributed evenly among the branch pipes, and is prevented from flowing toward the intake inlet so that the throttle valve and/or the supercharger that may be provided near the intake inlet is prevented from being contaminated by condensed water that may be released from the blowby gas.

This is particularly favorably achieved when the blowby gas introduction hole is located between two straight lines (L2) obtained by extrapolating side edges of an inner surface of the third branch pipe.

Preferably, the engine is provided with a supercharger, and each of the branch pipes is shorter than the main pipe.

Thereby, the intake manifold can be formed as a compact unit.

Thus, the intake manifold according to one aspect of the present invention allows the blowby gas to be distributed evenly to different branch pipes of the intake manifold, and minimizes the exposure of the intake air pressure sensor to the blowby gas.

### BRIEF DESCRIPTION OF THE DRAWING(S)

FIG. 1 is a schematic side view of an internal combustion engine according to an embodiment of the present invention;

FIG. 2 is a perspective view of an intake manifold of the engine;

FIG. 3 is a side view of the intake manifold;

FIG. 4 is a sectional view taken along line IV-IV of FIG. 2;

FIG. 5 is a graph comparing distributions of blowby gas flowing through different branch pipes of the intake manifold between the present embodiment and an example for comparison; and

FIG. 6 is a diagram illustrating flow lines of the blowby gas flowing into a first branch pipe in plan view.

### DESCRIPTION OF THE PREFERRED EMBODIMENT(S)

A preferred embodiment of the present invention is described in the following with reference to the appended drawings.

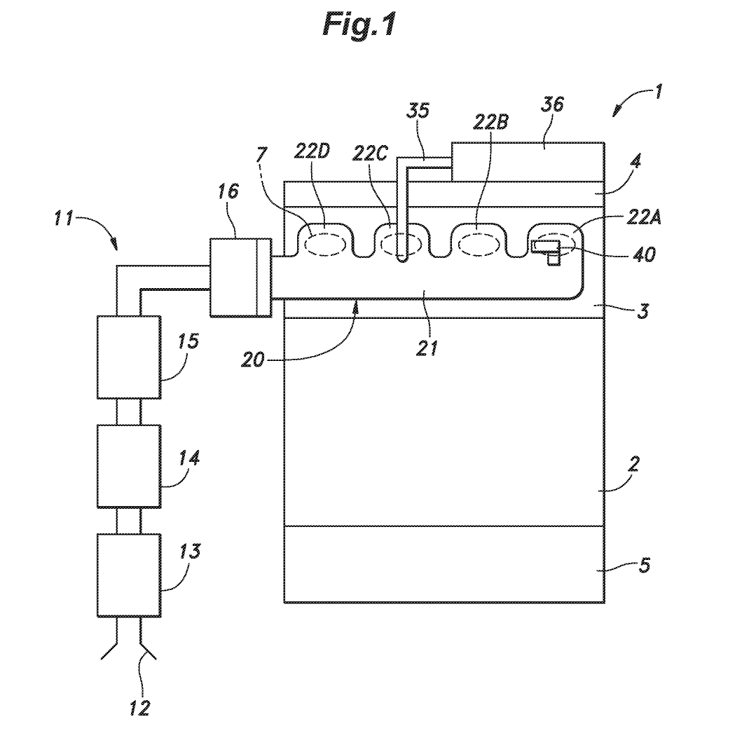

As shown in FIG. 1, an internal combustion engine 1 includes a cylinder block 2, a cylinder head 3 connected to the upper end of the cylinder block 2, a head cover 4 connected to the upper end of the cylinder head 3, and an oil pan 5 connected to the lower end of the cylinder block 2 in a per se known manner. The cylinder block 2 defines four cylinders extending in parallel to each other and arranged along an axial direction (cylinder row direction) of the cylinder block 2 in a single row. In the present embodiment, the cylinder block 2 is arranged transversely to a vehicle body not shown in the drawings, and the cylinder row direction coincides with the lateral direction of the vehicle body. Further, the cylinder block 2 is mounted on the vehicle body with a slight backward slant.

On the lower surface of the cylinder head 3 are formed four combustion chamber recesses which cooperate with the respective cylinders to define combustion chambers. The cylinder head 3 is provided with four intake ports 7 extending rearward from the respective recesses defining the combustion chambers, and opening to the rear side of the cylinder head 3, and four exhaust ports (not shown in the drawings) extending forward from the respective recesses defining the combustion chambers, and opening to the front side of the cylinder head 3.

The intake ports 7 are arranged in the cylinder row direction at a regular interval on the rear side of the cylinder head 3. An intake device 11 is attached to a rear side surface of the cylinder head 3. The intake device 11 includes an intake air inlet 12, an air cleaner 13, a supercharger 14, an intercooler 15, a throttle valve 16, and an intake manifold 20, in that order from the upstream side. The intake device 11 forms an intake air passage that communicates with the intake ports 7 via the intake manifold 20 for supplying intake air to the combustion chambers.

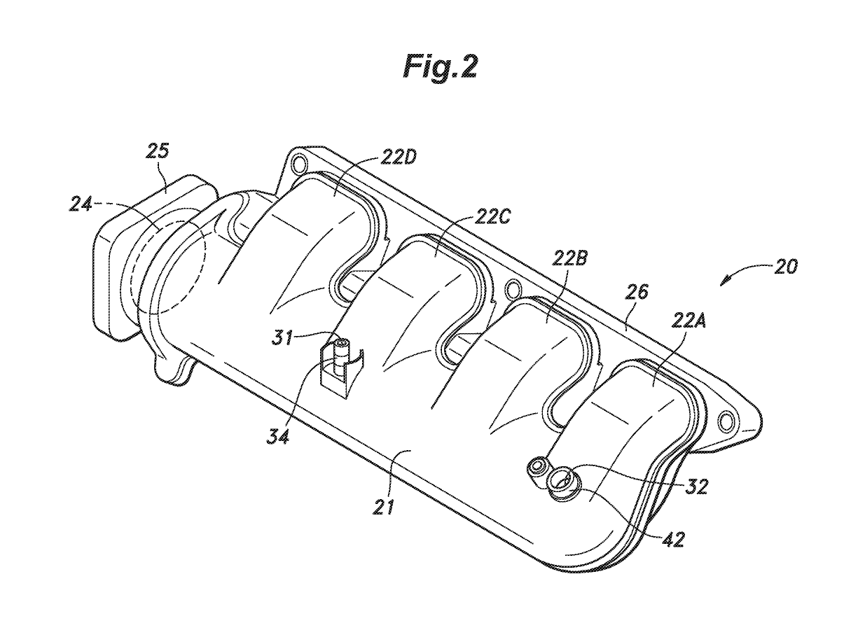

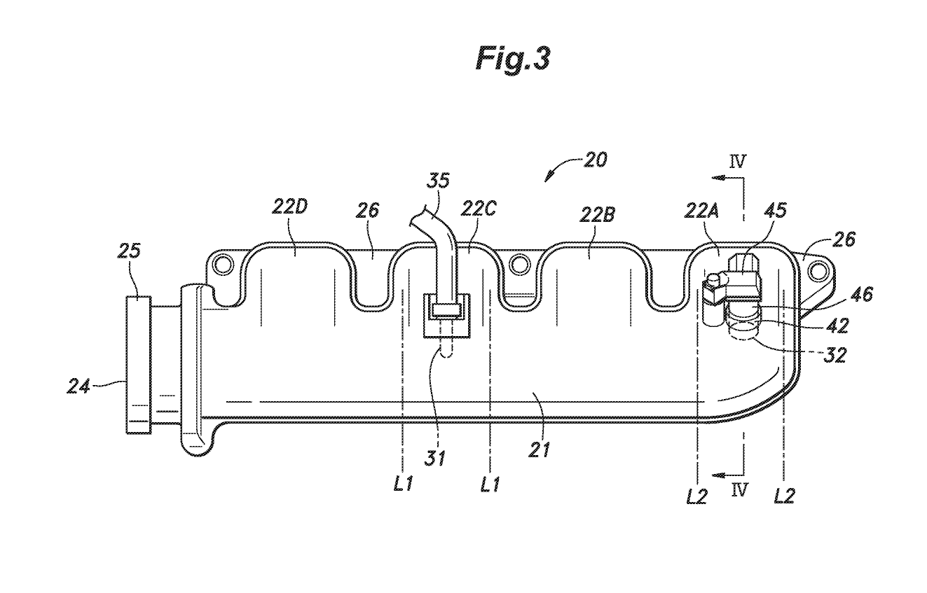

As shown in FIGS. 2 and 3, the intake manifold 20 includes a main pipe 21 extending substantially linearly in the cylinder row direction along the rear side of the cylinder head 3, and a plurality of branch pipes 22 (22A to 22D) extending from the main pipe 21 toward the respective intake ports 7 substantially in parallel to each other. The main pipe 21 has a substantially circular cross section, and extends substantially linearly in parallel with the rear side of the cylinder head 3. The main pipe 21 has an intake inlet 24 at one end in the longitudinal direction (cylinder row direction) and is closed at the other end. A fastening flange 25 is provided on the outer periphery of the inlet end of the main pipe 21. By fastening the fastening flange 25 to the throttle valve 16, the intake inlet 24 is connected to the outlet end of the throttle valve 16. The branch pipes 22 extend independently from each other from the main pipe 21 substantially orthogonally from the main pipe 21 and with an upward slant, and are arranged in the cylinder row direction at a regular interval. In the present embodiment, the branch pipes 22 consist of four branch pipes 22 corresponding to the respective intake ports 7. The branch pipes 22 include a first branch pipe 22A, a second branch pipe 22B, a third branch pipe 22C, and a fourth branch pipe 22D, in that order from the other end of the main pipe 21. Each branch pipe 22 is shorter in length than the main pipe 21.

The branch pipes 22 extend obliquely upward from an upper side part (upper front side part) of the main pipe 21 to the cylinder head 3. The intermediate part of each branch pipe 22 is bent toward the cylinder head 3 by approximately 90 degrees in such a manner that the downstream end of each branch pipe 22 faces substantially forward. The downstream ends of the branch pipes 22 are integrally connected to a common fastening flange 26 which is elongated in the cylinder row direction, and faces forward. A planar fastening surface 27 facing rearward is defined around the intake ports 7 on the rear side of the cylinder head 3. The fastening flange 26 is fastened to the fastening surface 27 with bolts so as to mechanically connect and communicate the branch pipes 22 to the respective intake ports 7.

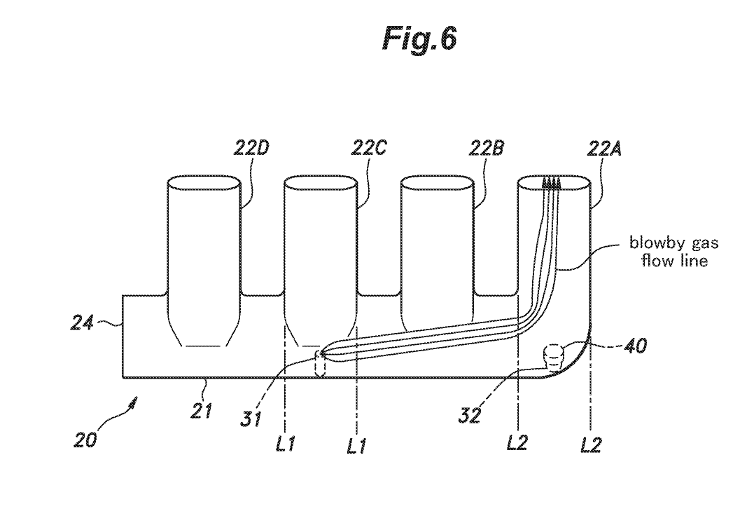

As shown in FIGS. 2 and 3, a blowby gas introduction hole 31 and a sensor mounting hole 32 are formed in the main pipe 21. The blowby gas introduction hole 31 and the sensor mounting hole 32 are holes penetrating the pipe wall of the main pipe 21. The blowby gas introduction hole 31 is disposed closer to the intake inlet 24 than the center of the main pipe 21 in the cylinder row direction is or between the intake inlet 24 than the center of the main pipe 21 in the cylinder row direction. The center of the main pipe 21 in the cylinder row direction is located between the second branch pipe 22B and the third branch pipe 22C in the present embodiment. The blowby gas introduction hole 31 is preferably located adjacent to the third branch pipe 22C, or is located so as to oppose the third branch pipe 22C. More preferably, the blowby gas introduction hole 31 is provided between two straight lines L1 and L1 obtained by extrapolating the side edges of the inner surface (inner wall) of the third branch pipe 22C in plan view (see FIGS. 3 and 6). The blowby gas introduction hole 31 may be disposed on the central axis of the third branch pipe 22C in plan view.

The blowby gas introduction hole 31 is provided in an upper part of the side wall of the main pipe 21 facing away from the cylinder head 3 (rear side), and extends substantially in a downward direction through the wall of the main pipe 21, and hence, the inner end of the blowby gas introduction hole 31 extends substantially vertically. The axial line of the blowby gas introduction hole 31 is offset rearward from the center line of the main pipe 21. A connecting pipe 34 is fitted into the blowby gas introduction hole 31 from outside so as to protrude from the outer surface of the main pipe 21. The connecting pipe 34 is connected to an end of a blowby gas supply pipe 35 as shown in FIG. 3. As shown in FIG. 1, the other end of the blowby gas supply pipe 35 is connected to the outlet of an oil separator 36 connected to the crankcase chamber. The oil separator 36 separates oil from the blowby gas supplied from the crankcase chamber. In the present embodiment, the oil separator 36 is provided in the head cover 4.

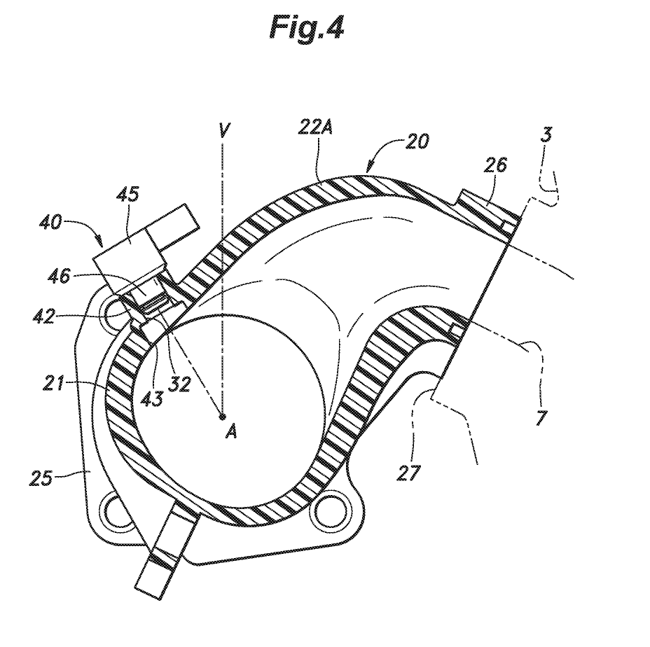

As shown in FIGS. 3 and 4, an intake pressure sensor 40 is fitted into the sensor mounting hole 32. As shown in FIGS. 2 to 4, the sensor mounting hole 32 is provided in the other end part (downstream end part) of the main pipe 21. In particular, the sensor mounting hole 32 is provided adjacent to the first branch pipe 22A which is positioned at the other end of the main pipe 21 remote from the one end thereof in the cylinder row direction, or so as to oppose the first branch pipe 22A. More preferably, the sensor mounting hole 32 is provided between two straight lines L2 and L2 obtained by extrapolating the side edges of the inner surface (inner wall) of the first branch pipe 22A in plan view. In the illustrated embodiment, the sensor mounting hole 32 is disposed on the central axis of the first branch pipe 22A in plan view. The sensor mounting hole 32 is provided in an upper part of a side wall of the main pipe 21 facing away from the cylinder head 3. In the illustrated embodiment, the central axial line of the sensor mounting hole 32 passes through the center A of the main pipe 21, and is oriented such that the central axial line forms an angle of about 35 degrees with respect to the vertical axial line V passing through the center A of the main pipe 21. In addition, the sensor mounting hole 32 is preferably provided in a boundary part between the first branch pipe 22A and the main pipe 21.

As shown in FIG. 4, the sensor mounting hole 32 consists of a hole having a circular cross section, and extending linearly. A cylindrical boss 42 having a flat free end projects from a part of the outer surface of the main pipe 21 adjacent to the sensor mounting hole 32 is provided in a protruding manner. The outer end of the sensor mounting hole 32 is surrounded by an annular boss formed integrally with the main pipe 21 and having a flat free end. The inner end of the sensor mounting hole 32 is provided with an enlarged diameter so as to define a recess 43. Thus, the recess 43 is provided with a cylindrical shape coaxial with the sensor mounting hole 32 and having a larger diameter than the sensor mounting hole 32.

The intake pressure sensor 40 includes a main body 45 incorporated with a pressure detecting part therein, and a pressure introduction pipe 46 protruding from the main body 45. The pressure detecting part may include a diaphragm for receiving a pressure and a piezoelectric element for detecting deformation of the diaphragm caused by the pressure. The pressure introduction pipe 46 is provided with a free end having an opening to receive a pressure to be detected (pressure receiving part), and a base end fitted into the main body 45 so as to transmit the received pressure to the pressure detecting part. The pressure introduction pipe 46 is inserted into the sensor mounting hole 32 and the main body 45 is fastened to the outer surface of the main pipe 21 via an ear piece extending laterally from the main body 45 and fastened to the cylindrical boss 42 with a screw. A seal is provided between the outer surface of the pressure introduction pipe 46 and the inner surface of the sensor mounting hole 32. The tip of the pressure introduction pipe 46 (pressure receiving part) is positioned in the sensor mounting hole 32 or in the recess 43.

The intake pressure sensor 40 is mounted in the sensor mounting hole 32 so as to be located between two straight lines L2, L2 extending from the respective sides of the inner surface of the first branch pipe 22A in plan view. Thus, the intake pressure sensor 40 is mounted to an upper part of the side wall of the main pipe 21 facing away from the cylinder head 3. The intake pressure sensor 40 is thus oriented such that the central axial line thereof forms an angle of about 35 degrees with respect to the vertical axial line V. In the illustrated embodiment, the central axial line of the intake pressure sensor 40 passes through the center A of the main pipe 21. In addition, the intake pressure sensor 40 is preferably provided at a boundary part between the first branch pipe 22A and the main pipe 21.

The mode of operation and advantages of the intake manifold 20 configured as described above are described in the following. Since the intake manifold 20 is provided in the internal combustion engine 1 provided with the supercharger 14, the inertia effect for the intake air is not required to be considered. Therefore, the branch pipes 22 are not required to be long, and are substantially shorter than the main pipe 21. This is advantageous for a compact design of the engine.

The air admitted from the intake inlet 24 flows through the main pipe 21 in the lengthwise direction thereof. Since the blowby gas introduction hole 31 is provided closer to the intake inlet 24 than the central point of the main pipe 21 is in the lengthwise direction thereof. The intake air in the main pipe 21 generally flows from the intake inlet 24 to the other end thereof adjoining the first branch pipe 22A. However, because the blowby gas introduction hole 31 is positioned relatively close to the fourth branch pipe 22D and the third branch pipe 22C, the blowby gas is forwarded to the fourth branch pipe 22D and the third branch pipe 22C in a preferential manner. Therefore, in spite of the prevalent flow of the intake air in the main pipe 21 directed toward the other end thereof, the blowby gas can be supplied to the four branch pipes 22 in a relatively even manner.

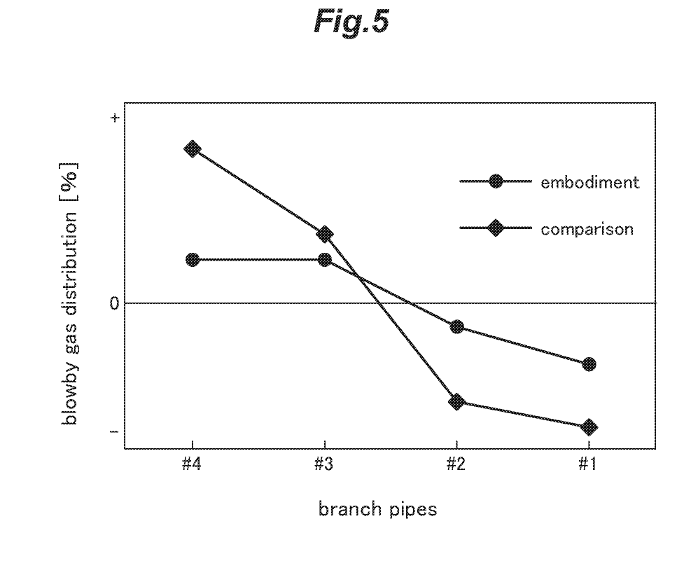

FIG. 5 is a graph comparing the ways the blowby gas is distributed among the four branch pipes 22 between the present embodiment where the blowby gas introduction hole 31 is provided opposite to the third branch pipe 22C and a comparison example where the blowby gas introduction hole 31 is provided opposite to the first branch pipe 22A. In either case, the blowby gas introduction hole 31 is positioned so as to oppose the center of the corresponding branch pipe. The ordinate in this graph indicates the deviation of the flow rate Fn of the blowby gas of each branch pipe from the average value (average value Fav of the flow rates of the blowby gas among the four branch pipes 22) divided by the average flow rate Fv or ((Fav−Fn)/Fax×100) [%]. The positive value indicates that the flow rate of the blowby gas in the corresponding branch pipe is smaller than the average value, and the negative value indicates that the flow rate of the blowby gas in the corresponding branch pipe is greater than the average value. The smaller this value is, the closer to the average value the flow rate is. As can be seen from this graph, in the case of the comparison example, the flow rates of the blowby gas in the branch pipes on the downstream side is significantly greater than those in the branch pipes on the upstream side. In the case of the present embodiment, this difference is significantly reduced. This owes to the fact, the blowby gas introduction hole 31 is placed relatively close to the fourth branch pipe 22D and the third branch pipe 22C so that the blowby gas is more actively supplied to these branch pipes on the upstream side.

In the case where the intake manifold 20 has four branch pipes 22 as is the case with this embodiment, the blowby gas introduction hole 31 is located at a position aligning with the third branch pipe 22C in the cylinder row direction, and in particular at a position located between two straight lines L1 and L1 which are obtained by extrapolating the two side edges of the inner surface of the inner wall of the third branch pipe 22C. If the blowby gas introduction hole 31 is provided more on the side of the intake inlet 24 (upstream side) than the position corresponding to the third branch pipe 22C in the cylinder row direction, the blowby gas becomes more likely to reach the throttle valve 16 so that the possibility of condensed water that may be released from the blowby gas adhering to the throttle valve 16 increases.

The blowby gas introduction hole 31 is provided in an upper rear part of the main pipe 21, and is passed downward in the wall of the main pipe 21, so that the blowby gas flows through circumferentially along the inner surface of the main pipe 21 from the blowby gas introduction hole 31, and is smoothly distributed to the respective branch pipes 22. As can be appreciated by a person skilled in the art, as the flow path length of the blowby gas in the main pipe 21 becomes longer, the distance to the blowby gas introduction hole 31 differs correspondingly little from one branch pipe to another (or as compared to the total length of the flow path of the blowby gas). Therefore, as the branch pipe moves away from the blowby gas introduction hole 31, the difference in the amount of blowby gas distribution becomes less significant.

Since the intake pressure sensor 40 is fitted into the sensor mounting hole 32 provided in the downstream end part (the other end part) of the main pipe 21, the flow of the blowby gas in the main pipe 21 is directed from the blowby gas introduction hole 31 to the respective branch pipes 22 in such a manner that the intake pressure sensor 40 becomes less exposed to the blowby gas. Furthermore, since the sensor mounting hole 32 is provided in the upper rear part of the wall of the main pipe 21 (away from the cylinder head 3), the blowby gas flowing into the branch pipes 22 is directed toward the side of the cylinder head 3 so that the exposure of the intake pressure sensor 40 to fresh blowby gas is minimized. Therefore, the intake pressure sensor 40 is protected from the corrosive effect of the condensed water that may be released from the blowby gas, and a measurement failure that could be caused by the freezing of the condensed water can be avoided.

FIG. 6 shows the flow lines of the blowby gas flowing from the blowby gas introduction hole 31 into the first branch pipe 22A in the main pipe 21 obtained by computer simulations. The main pipe 21 and the branch pipes 22A to 22D shown in FIG. 6 are represented by the inner wall surface of each pipe. As shown in FIG. 6, in flowing from the blowby gas introduction hole 31 to the first branch pipe 22A, the blowby gas initially passes along the rear part of the main pipe 21 (provided with the blowby gas introduction hole 31), and then passes along the front part of the main pipe 21 as the gas flow approaches the first branch pipe 22A. Therefore, the main flow of the blowby gas avoids the sensor mounting hole 32 and the intake pressure sensor 40 which are provided in the rear part of the main pipe 21.

Since the intake pressure sensor 40 is provided in the upper part of the main pipe 21, the condensed water that may be released from the blowby gas stays in the bottom part of the main pipe 21 so that the intake pressure sensor 40 is prevented from coming into contact with the condensed water.

Since the changes in the air flow caused by the changes in the opening angle of the throttle valve 16 are attenuated as the gas flow flows toward the other end part (downstream end part) of the main pipe 21 remote from the intake inlet 24, the pressure fluctuation is so reduced in the other end part of the main pipe 21 that the intake pressure sensor 40 placed in the remote end part of the main pipe 21 can accurately measure the pressure of the main pipe 21 in a reliable manner. In particular, since the pressure introduction pipe 46 of the intake pressure sensor 40 is disposed inside the sensor mounting hole 32 or the recess 43, the intake pressure sensor 40 is additionally protected from rapid pressure changes so that the pressure of the main pipe 21 can be measured with a high accuracy.

Although the present invention has been described in terms of a specific embodiment, the present invention is not limited by this particular embodiment, but various parts thereof can be substituted and modified without departing from the spirit of the present invention. For example, the intake manifold 20 may have other numbers of branch pipes such as three branch pipes 22 as is the case with a three-cylinder in-line engine and a six-cylinder V-engine.

In such a case, the intake manifold 20 has the first to third branch pipes 22A to 22C at a regular interval from the other end to the one end of the main pipe 21, and the second branch pipe 22B is located at the center of the main pipe 21 in the longitudinal direction. The blowby gas introduction hole 31 is provided closer to the intake inlet 24 than the center in the longitudinal direction of the main pipe 21 is. In other words, the blowby gas introduction hole 31 is provided between the center of the second branch pipe 22B and the third branch pipe 22C. The sensor mounting hole 32 is formed in the other end part (downstream end part) of the main pipe 21. In particular, the sensor mounting hole 32 may be located between two straight lines L2, L2 obtained by extrapolating two side edges of the inner surface of the first branch pipe 22A in plan view.

1. An intake manifold for an internal combustion engine including a plurality of cylinders arranged in a row, comprising:
a main pipe extending in a cylinder row direction of the engine, and having an intake inlet in one end part thereof;
a plurality of branch pipes extending from the main pipe to respective intake ports of the engine;
a blowby gas introduction hole provided in a part of the main pipe located between the intake inlet and a center of the main pipe with respect to the cylinder row direction; and
an intake pressure sensor provided in another end part of the main pipe remote from the one end part thereof.

2. The intake manifold as defined in claim 1, wherein the intake pressure sensor is provided on a side of the main pipe facing away from the cylinder head.

3. The intake manifold as defined in claim 2, wherein the intake pressure sensor is provided in an upper part of the main pipe.

4. The intake manifold as defined in claim 3, wherein the intake pressure sensor is provided in a range extending from a vertical line passing through a center line of the main pipe extending in the cylinder row direction to a line forming a 35 degree angle relative to the vertical line around the center line.

5. The intake manifold as defined in claim 3, wherein the intake pressure sensor is provided adjacent to the branch pipe most remote from the one end of the main pipe.

6. The intake manifold as defined in claim 5, wherein the intake pressure sensor is located between two straight lines obtained by extrapolating side edges of an inner surface of the branch pipe most remote from the one end of the main pipe in plan view.

7. The intake manifold as defined in claim 6, wherein a pressure receiving part of the intake pressure sensor is positioned in a hole or recess formed in a wall of the main pipe.

8. The intake manifold as defined in claim 1, wherein the branch pipes extend from a side of the main pipe facing the cylinder head with an upward slant followed by a downward curve, and the blowby gas introduction hole is formed in an upper part of a side of the main pipe facing away from the cylinder head.

9. The intake manifold as defined in claim 8, wherein an inner end of the blowby gas introduction hole extends substantially vertically.

10. The intake manifold as defined in claim 8, wherein the branch pipes include a first branch pipe, a second branch pipe, a third branch pipe and a fourth branch pipe arranged in that order from the other end part of the main pipe, and the blowby gas introduction hole is located adjacent to the third branch pipe.

11. The intake manifold as defined in claim 10, wherein the blowby gas introduction hole is located between two straight lines obtained by extrapolating side edges of an inner surface of the third branch pipe.

12. The intake manifold as defined in claim 1, wherein the engine is provided with a supercharger, and each of the branch pipes is shorter than the main pipe.
